(19) United States
(12) Patent Application Publication
(10) Pub. No.: US 2014/0317204 A1
(43) Pub. Date: Oct. 23, 2014

(54) TEXT-BASED ELECTRONIC COMMUNICATION AND STORAGE

(71) Applicant: Redsource Interactive, LLC, San Luis Obispo, CA (US)

(72) Inventor: Andrew Stitt, San Luis Obispo, CA (US)

(73) Assignee: Redsource Interactive, LLC, San Luis Obispo, CA (US)

(21) Appl. No.: 13/868,070

(22) Filed: Apr. 22, 2013

(51) Int. Cl. H04L 12/58

(52) U.S. Cl. CPC H04L 51/04
USPC 709/206

(57) ABSTRACT

Systems and methods are provided for incentivizing. Point(s) are provided for solutions to problems, answers to questions, resolution to issues, etc. and these points may be utilized to obtain products and/or services.

### FIELD OF THE INVENTION

The invention relates generally to real-time text based electronic communications and more particularly to a website providing the ability to store all or part of a real-time, text-based electronic communication for future reference.

### BACKGROUND OF THE INVENTION

Numerous forms of text based electronic communications exist, such as electronic mail (email), instant messaging, online chat rooms, etc. Oftentimes people will communicate via these electronic avenues of communication to resolve problems or discuss a particular issue/topic. However, once the conversation is completed the resolution is either discarded or, in the case of emails, remains available but only to the participants who save the email chain.

Various websites, including but not limited to experts-exchange.com and answers.yahoo.com, attempt to broaden the audience that has access to the stated problem and its resolution by providing an electronic bulletin board where a user may post a question and receive answers to the question from other users who may be knowledgeable, professional or even experts on that particular topic. While such websites accomplish this task with regard to posted questions and answers, they fail to provide the ability to capture and store real-time or substantially real-time conversations or conversations that take place off site.

Websites such as strtc.oracle.com/imtapp/app/prelogin.uix provide an online meeting place to collaborate on a problem. At the termination of the meeting, the host may archive some or all of the voice conversation and documents, poll results, and attendee information. A user is then able to search through the archived meetings by conference title, host name or conference id to listen to the conversation and view the documents. However, this is a voice conversation, there is no provision for saving the conversation to another website and there is no incentive provided for archiving the meeting.

In view of the foregoing, it would be advantageous to provide an improved online question and answer website which provides an ability to have a text-based conversation in real-time, or substantially real-time then save the conversation for future reference. It would also be advantageous to provide an improved online question and answer website which provides an option to store within the website text-based conversations which occur outside of the website. It would further be advantageous to provide such a website which incentivizes one or more participants of the conversation to store all or part of the conversation onto the website.

### BRIEF SUMMARY OF THE INVENTION

Many advantages of the invention will be determined and are attained by the invention, which in a broadest sense provides systems and methods for storing real-time or substantially real-time text-based electronic communications and incentivizes its users to submit the communications for storage.

Systems and methods are provided for storing real-time, text-based electronic communications via a communications network. The system includes a server connected to the communications network. The server provides a user interface for real-time, text-based communications capabilities between users of the system. The server also has a database in electrical communication with the user interface. The database is configured to store at least a portion of a real-time text based communication/conversation and is further configured to store an incentive awarded to at least one participant of the conversation.

A method is also provided for storing at least a portion of a real-time, text-based electronic communication, which occurs via a communications network. The method includes providing a server configured to provide real-time text-based electronic communication capabilities to users of the network. The server receives an instruction to save a portion of a real-time text based communication and receives an instruction to associate an incentive with a participant of the conversation. As a result of the instruction the server stores the portion of the communication and the association.

One or more embodiments of the invention provide a method for storing at least a portion of a real-time, text-based electronic communications which occurs via a communications network. The method includes a user posting a question in an electronic chat room and receiving a response to the question from another user in the chat room. If the user determines that the response answers the question, the user may decide to save the question and answer and award an incentive to the user who provided the response. The user then stores the question, the answer and the incentive on a server associated with a question and answer website.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram of a Question and Answer system in accordance with embodiments of the invention;

FIG. 2 is a flowchart illustrating operation of a Question and Answer system in accordance with embodiments of the invention;

FIG. 3 is a sample display illustrating a text-based electronic communication in accordance with embodiments of the invention;

FIG. 4 is a sample display illustrating a portion of the text-based electronic communication of FIG. 3 ready for submission to a Question and Answer system in accordance with embodiments of the invention; and,

FIG. 5 is a sample display illustrating a sample form for submitting text-based electronic communication to a Question and Answer system in accordance with embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

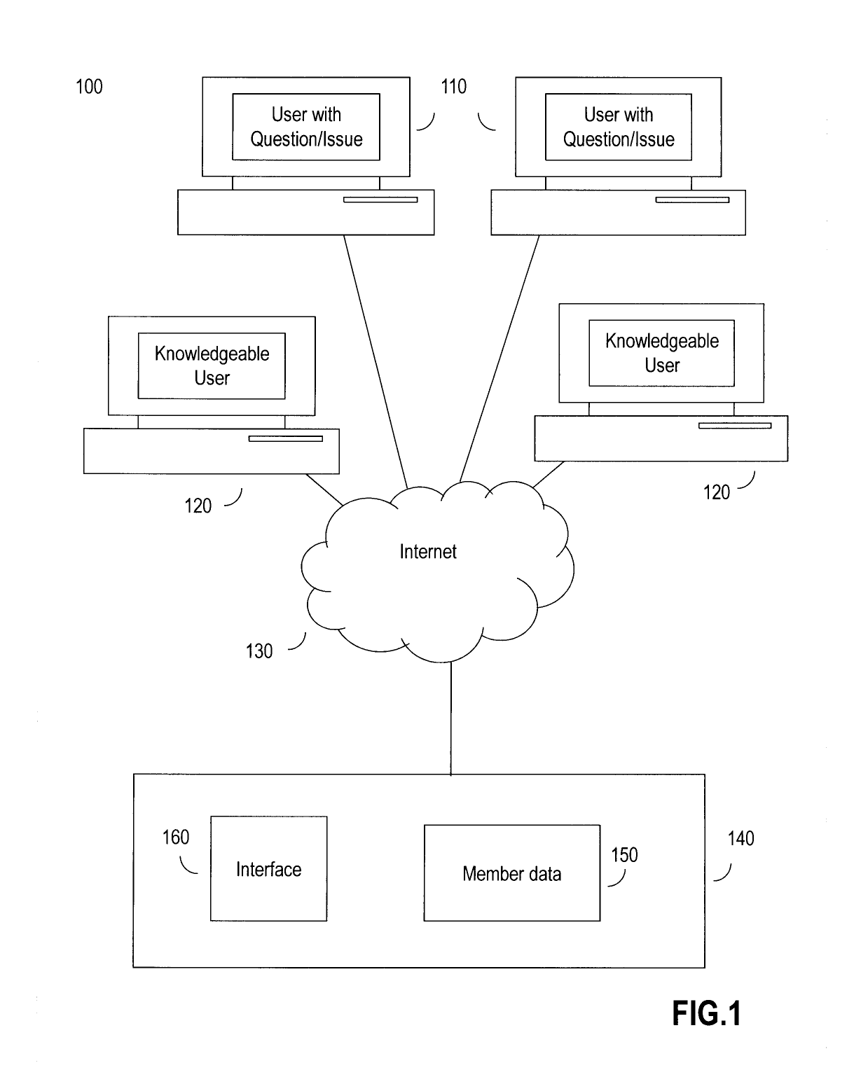

Referring to the drawings in detail wherein like reference numerals identify like elements throughout the various figures, there is illustrated in FIGS. 1-5 systems and methods for storing text-based, real-time electronic communications (conversation) and incentivizing one or more of the participants to the conversation to store at least a portion of the conversation in the system so that it may be referenced by others.

The following description will refer only to online chat rooms but those skilled in the art will recognize that the invention is not so limited. The invention may be employed with instant messaging or any other type of text-based real-time or substantially real-time electronic messaging system. The principles and operations of the invention may be better understood with reference to the drawings and the accompanying description.

Referring to FIG. 1, in an exemplary embodiment of the invention, the system 100 includes users 110 and users 120 who connect to server 140 via the Internet 130 or via some other network. Those skilled in the art will recognize that there are various conventional ways that a user 110 or user 120 can connect to the system and that any of these methods may be employed without departing from a scope of the invention. Among such ways, although not exhaustive, are through a kiosk, direct connection, dial-up connection, a secure or unsecured connection, virtual private network (VPN), cable or satellite connection, a local area network (“LAN”), any other suitable wired, wireless, or optical connection, or a combination thereof. Those skilled in the art will also recognize that while users 110 and 120 have been set forth as separate and distinct, it is possible and anticipated that users 110 may fulfill the role of user 120 and visa-versa. Further, while 2 of each user type 110/120 have been illustrated, this was only done to avoid overcomplicating the drawing and the system is not so limited.

Server 140 includes a user interface 160 and a member database 150. Database 150 stores user information, conversations and incentives earned by each user. Those skilled in the art will recognize that database 150 may be a single database or multiple databases and still fall within a scope of the invention. Those skilled in the art will also recognize that while a single server 140 is illustrated that multiple servers may be employed.

User devices 110/120 may include any suitable computing equipment for accessing and interacting with content (e.g., web pages) over Internet 130 or some other communications network 130 (e.g. television network, cable network, etc.). For example, as shown in FIG. 1, user device 120 may be a desktop computer. In other examples, user device 120 may be a laptop computer, tablet computer, telephone (e.g., smartphone), personal digital assistant (“PDA”), BlackBerry™ device, television, set-top cable or satellite box, or any other suitable computing device. Since different devices may be employed by the users, reference to any one type of device will be understood to include any or all types of suitable computing equipment. For ease of description, the remaining disclosure will only refer to user computer 110/120.

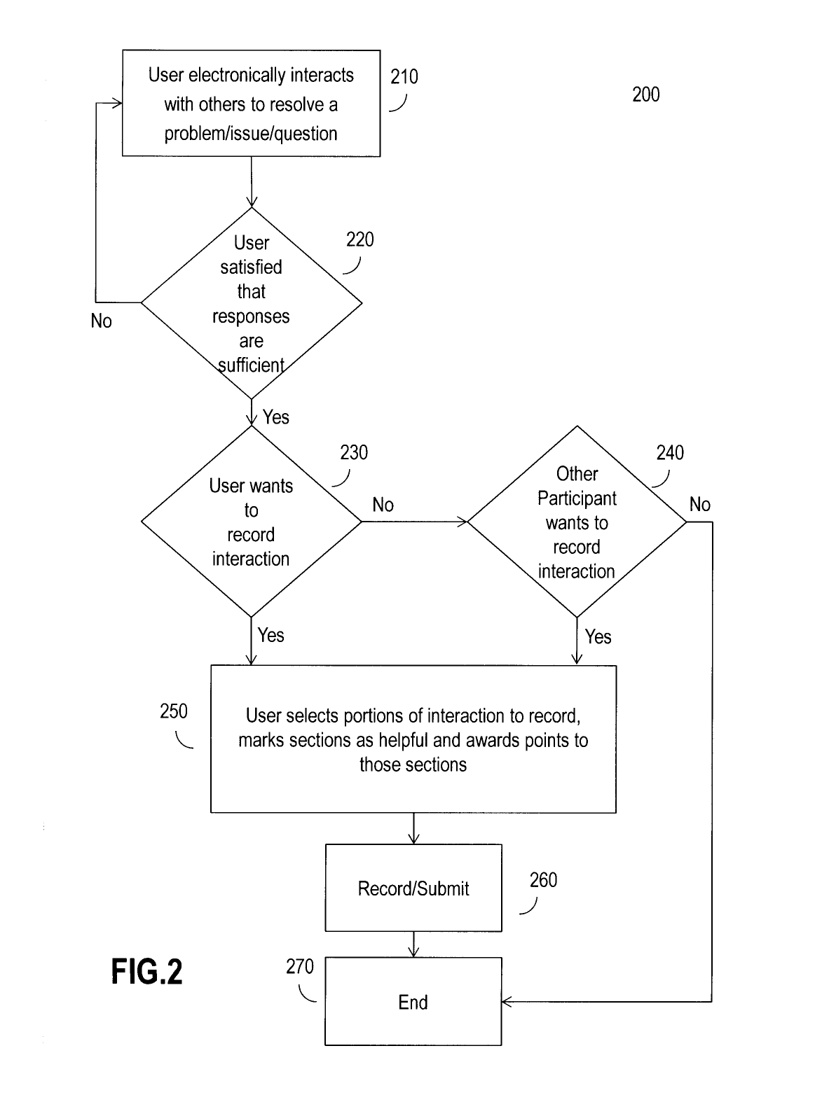

Referring to FIGS. 1 and 2, user 110/120 connects to server 140 via a user interface 160. Interface 160 may provide user 110 with various options such as register, sign-in, review/edit account, store a conversation, start a conversation, join a conversation, invite one or more people to a conversation, search by topic, search by key words or search by any other conventional search method. The system 100 may be a closed system which requires user 110/120 to sign-in prior to performing operations on the website, an open system which does not require logging in or it can be a hybrid; allowing some operations to be performed without logging in and requiring log-in for other operations. For ease of explanation, the following description shall be limited to a closed system; however, this in no way is intended to limit the invention as such.

Registration: The first time user 110/120 attempts to access system 100, registration may be required. User 110/120 registers (e.g., on the System's web page or user interface 160) with system 100, and sets up their account. Registration may include entry of information such as name, unique user identification, password, contact details (e.g., e-mail, address etc.) and possibly other conventional information as may be required for the operation of the System. If a user 110/120 expects to respond to one or more questions, registration may, or may not, require user 110/120 to submit qualification information for any topic that they intend to post responses to.

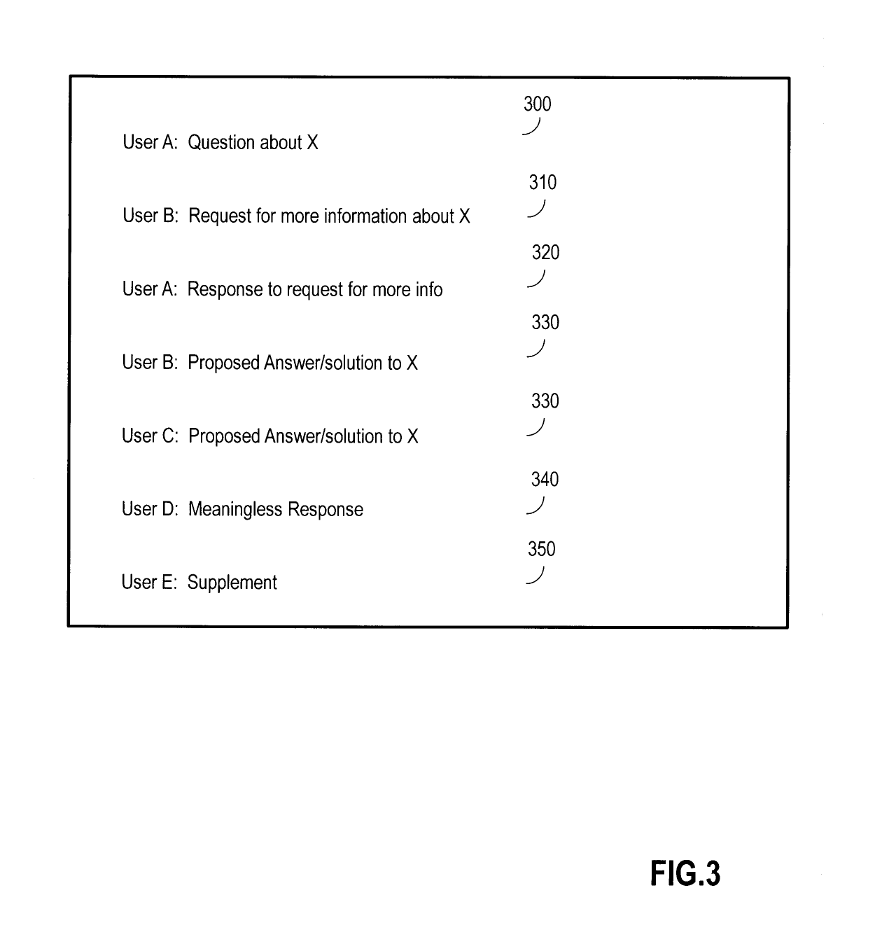

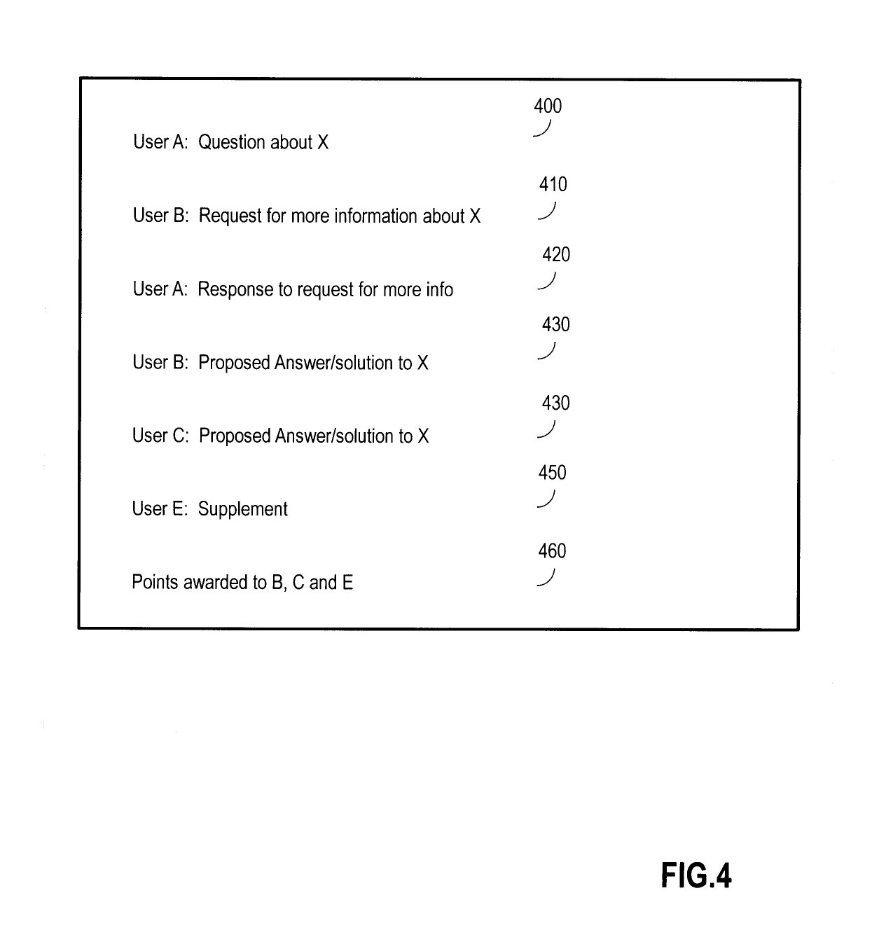

The Conversation (FIG. 3): Once registered, user 110/120 may make a selection of the above operations. Assuming user 110 has a question/issue/problem (question) and decides to have a real-time conversation (FIG. 3), user 110 can join an existing conversation, start a new conversation and wait for people to join, invite people to a new conversation or join an existing conversation and invite one or more participants to a private chat. The technology for providing these options is conventional and thus will not be further described. Regardless of how the conversation is started, at any time during the conversation if user 110 determines that all or part of his/her question 300 has been resolved user 110 may elect to store the conversation or relevant portions of the conversation and award points to the user 120 or users 120 who assisted with the resolution (e.g. FIG. 4).

Points: The number of points awarded may be the same for everyone, may be subjective, or may be preset (e.g. identified at the outset of the conversation). Point totals may be the entirety of the points available for the conversation or they may be additional points that are added to a default point total available for a conversation, depending upon the design choice of the system administrator. Points awards may be whole number values or include partial points (for ease of explanation the following description shall only refer to points, but such usage will be understood to include points, partial points or both). Points may be employed to purchase products and/or services, enter drawings, games, raffles and/or to apply for job opportunities. Depending upon the design choice of the system, there may be a standard point count awarded for each operation (e.g. X point(s) for each response to a question, Y point for posting the best response, Z points for being the first to respond, where X, Y and/or Z may be the same or different, etc.), there may be different point counts or levels awarded for different types or numbers of operations, points may be awarded on an objective or subjective basis, or any combination thereof. The system may be configured such that points may or may not be required for starting a conversation or there may be an option for offering points up front to make the conversation seem more desirable. The system may provide different classification of points (e.g. question points, response points) and require certain points to be purchased, earned and/or won. While certain specific point schemes are disclosed, those skilled in the art will recognize that the invention is not intended to be limited to any one specific point scheme.

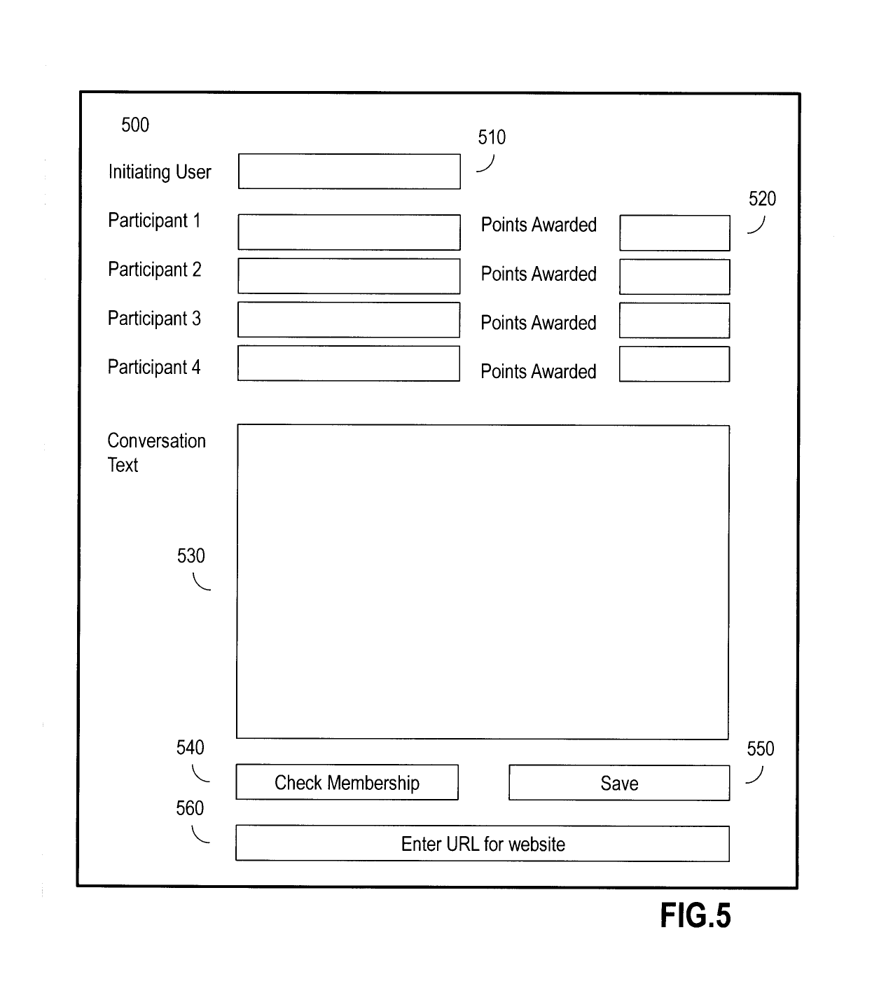

Saving: Server 140 may provide a save option which requests a point award for each participant (FIG. 5, 520) and which provides the option to save the entire conversation or a portion (FIG. 5). In the event that only a portion is selected, the server may reproduce the entire conversation in box 530 and require the user 110 to delete portions that are not relevant, or it may require user 110 to cut and paste the relevant portions into box 530. In one or more embodiments, conversation box 530 may be separated into multiple boxes (e.g. one for the question, 1 for the best answer and 1 or more for the remaining answers). Once the points are awarded and, if appropriate, the conversation is redacted, the system saves the conversation for future reference by other users 110/120.

After registration and/or logging-on to the system 100, user 120 may begin responding to users 110. User 120 may scroll through a list of available conversations, perform a search for a particular topic and scroll through the available conversations within that topic, accept invitation(s) to join one or more conversations or simply start a new conversation. In one or more embodiments of the invention, the system may suggest one or more topics or conversations to user 120 based on that user's profile. If user 120 takes part in a conversation and provides a sufficient solution to the posed question, then user 120 may either receive or be eligible to receive incentive points depending upon the design choice of the system administrator and whether or not the conversation is saved. In one or more embodiments each user 120 or some of the users 120 participating in a conversation may share the points allocated to that conversation, receive the entire point allocation, one user 120 may receive all of the points or no points may be allocated. At some point during a conversation, user 110 may determine that the question or a portion of the question is resolved and communicate the same to the other participants of the conversation. At such time, user 110 has the option of saving the conversation or a portion of the conversation and awarding points to the users 120. However, user 110 may not have time or may not, for some other reason, decide to save the conversation. In one or more embodiments, user 110 may provide the save option to one of the other participants 120 in the conversation. If that occurs, user 110 may be provided the option to award the points and then provide the save option to user 120, user 110 may select which users 120 receive points and each selected user 120 receives a default point value, user 120 can ignore the point award option and either users 120 each receive a default point value or no point value depending on the system design.

The above description has been limited to conversations which take place on the same server as the storage. However, the invention is not so limited. In one or more embodiments of the invention it is contemplated by the inventor that a conversation could take place in a remote chat room and then uploaded to the server 140. In this scenario, user 110 could login to server 140 and select save conversation. A window similar to that of FIG. 5 could be presented to user 110. User 110 could then either manually populate the various boxes or the boxes could be automatically filled by server 140. To automatically fill the boxes, user 110 would provide the website with a text file of the chat conversation and a mapping of participant names as used in the conversation. If the participant is not known by the website, user 110 could be requested to provide an email address of that participant so an email could be sent to the user offering the opportunity to join and receive the points award. System 100 parses the text file and attempts to associate participants with lines of conversation. The results of parsing could be shown to user 110 for approval or edit, and then user 110 can select which comments are eligible for points. At some point (either once all boxes are populated, after each name is entered, or some variation in between) user 110 may select radio box 540 to check which, if any of the participants are members of the website. If a participant is already a member then user 110 may award points to that user. However, if a participant 120 is not already a member then user 120 may either leave off the points award for that participant, select an option that sends an email or some other message to the participant offering membership and if the participant accepts then award points to that participant, or award points to that participant in hopes that the participant will subsequently join (at which time the points will be awarded to that user's 120 account). Alternatively or additionally, the conversation could be uploaded to one or more other websites. For example, during the save process, user 110 could be provided the option of entering the web address of a different website and when user 110 selects this option the file is sent to that website for processing and storage.

Thus it is seen that systems and methods are provided for incentivizing participants in a real-time or substantially real-time, text-based electronic communication to store the results of the conversation for future reference by other users. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, the system is described as being set up as a single server that communicates over the Internet. However, the system could also function with multiple servers configured to perform the various operations and/or communications could take place via a network other than the Internet. The system is described in regard to real-time or substantially real-time text based conversations; however, it is contemplated that users who have email conversations will upload all or a portion of the email conversation to the system. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for storing real-time, text-based electronic communications via a communications network, the system comprising:
a server connected to the communications network, said server having:
a user interface for providing real-time, text-based communications capabilities between a plurality of users of the system; and,
a database in electrical communication with said user interface, said database being configured to store at least a portion of a real-time text based communication and further configured to store an incentive awarded to at least one participant of said real-time text based communication.

2. The system according to claim 1 wherein said database comprises a plurality of databases; and, said at least a portion of a real-time text based communication and said incentive are stored in different databases.

3. The system according to claim 1 wherein said database is configured to store an entirety of said real-time text based communication.

4. The system according to claim 1 wherein said database is further configured to store participant information associated with said real-time text based communication.

5. The system according to claim 1 further including a user computer, selectively connected to the communications network and configured to communicate a question posed by a user of the system for receipt by said interface.

6. The system according to claim 1 further including a user computer, selectively connected to the communications network and configured to communicate a response to said question for receipt by said interface.

7. A method for storing at least a portion of a real-time, text-based electronic communications which occurs via a communications network, said method comprising the steps of:
providing a server configured to provide real-time text-based electronic communication capabilities to a plurality of users;
said server receiving an instruction to save a portion of a real-time text based communication;
said server receiving an instruction to associate an incentive with a participant of said conversation; and,
said server storing said portion of a real-time text based communication and said association.

8. The method according to claim 7 further including said server storing an entirety of said real-time text based communication.

9. The method according to claim 7 further including, said server separating a part of said portion of said real-time text based communication and storing it separately from a remaining part of said real-time text based communication.

10. The method according to claim 9 wherein said part of said portion is a question and said remaining part includes an answer to said question.

11. The method according to claim 7 further comprising said server storing said portion of said real-time text based communication on a remote server.

12. The method according to claim 7 wherein said incentive includes a point value.

13. The method according to claim 7 further comprising said server receiving an instruction to associate another incentive with another participant of said conversation.

14. A method for storing at least a portion of a real-time, text-based electronic communications which occurs via a communications network, said method comprising the steps of:
a user posting a question in an electronic chat room;
said user receiving a response to said question from another user in said chat room;
said user determining that said response answers said question and deciding to save said question and answer;
said user awarding an incentive to said another user and storing said question, said answer and said incentive on a server associated with a question and answer website.

15. The method according to claim 14 further comprising said user logging into said website prior to saving.

16. The method according to claim 14 further including said user and said another user logging into said website prior to said saving.
